(19) United States
(12) Patent Application Publication
(10) Pub. No.: US 2005/0050396 A1
(43) Pub. Date: Mar. 3, 2005

(54) Tamper-proofing watermarked computer programs

(75) Inventors: Clark David Thomborson, St. Heliers (NZ); Yong He, Mt. Albert (NZ); Ram Abhinav Somaraju, Glenfield (NZ); Jasvir Nagra, (US)

Correspondence Address: MERCHANT & GOULD PC, P.O. BOX 2903, MINNEAPOLIS, MN, 55402-0903, US

(73) Assignee: AUCKLAND UNISERVICES LIMITED, AUCKLAND (NZ)

(21) Appl. No.: 10/850,195

(22) Filed: May 20, 2004

Related U.S. Application Data
(60) Provisional application No. 60/480,140, filed on Jun. 20, 2003.

(51) Int. Cl. G06F 11/00

(52) U.S. Cl. 714/38

(57) ABSTRACT

In the tamperforoofing of watermarked computer programs, a constant in the computer program is replaced with a function call. The function call has one or more arguments that point to a data structure built by said program. The replacement can involve referencing a data sub-structure defined by one or more of its arguments, and decoding the constant from the sub-structure.

### FIELD OF THE INVENTION

The present invention relates to the tamperproofing of watermarked computer programs.

### DEFINITIONS

Reference in this specification to a computer program includes fragments, or code portions of programs. The term “code” and “software” are used as synonyms for “program”. “Program” further includes all forms of source and object code, whether stored or at run time (instantiated).

### BACKGROUND

Software piracy—the illegal copying and resale of an application—is estimated to be a U.S.$12 billion per year industry. Piracy is therefore a major problem and one approach to coutering this problem is by proving software ownership. This can be achieved by embedding watermarks into programs.

A known approach to embedding watermarks in programs is taught in International Patent Publication No. WO 99/64973, published on 16 Dec. 1999, entitled Software Watermarking Techniques (inventors: Collberg, C. and Thomborson, C.). Such watermarked programs build a special, recognisable, data structure representing a particular graph w that serves as a watermark. The presence of a representation of this graph, in the data structures built by the program, constitutes a proof that the program has been marked by its authors or owners.

Collberg and Thomborson teach the embedding of a watermark in the topology of a dynamically built graph structure in the form of a parent-pointer tree, which is a type of Planted Plane Cubic Tree (PPCT). More specifically, Collberg and Thomborson embed a structure W into a program P, using embedder E to produce program P_{w} such that W can be reliably located and extracted from P_{w}, using extractor X even after P_{w} has been subjected to code transformations such as obfuscation, translation and optimization. W has a mathematical property that allows it to be argued that W is present in P_{w} as a result of deliberate action.

Refering then to FIG. 1, a program P 12 is provided to an embedder module E 14. The embedder function requires a “representation” function r: G→S that maps graphs in set G onto the set S of data structures that may be used by programs in P. This mapping and its inverse r⁻¹:S→G must be efficiently computable. A good choice for G is the set of planted planar cubic trees of a given size, say those with 1000 leaf nodes. Whatever the specific choice of G, a fundamental requirement on this set of graphs is that it be efficiently enumerable, in the following sense: G must have an associated pair of encoding and decoding functions (e, d), where the encoder function e of the codec maps a set of integers onto the set G. The decoder d is the inverse of e, mapping elements of G onto the the set of integers. The pair (e, d) is referred to as a “graph codec”.

Now, let sεS. Using a natural representation function r, the nodes of r⁻¹(s) are the data structure objects in s and the arcs in r⁻¹(s) are pointer references from one object to another in s. There is an ordering on the outgoing arcs at each node, defined by the order in which the pointer references appear in computer memory representation of the data-structure object. From this point forward, the term “graph” refers to a “directed graph”, possibly disconnected, with a total ordering on the outgoing arcs at each node.

The embedding function E 14 takes a program P, a watermark integer w and a secret key input sequence k and produces a Program P_{w} 16, such that, when P_{w} is run on the key input k, it produces a data structure S_{w} containing the watermark w. Formally this containment of w in S_{w} may be expressed as follows:
d(r⁻¹(S_{w}))=w

The corresponding extractor function X 18 takes a watermarked program P_{w}, “de-represents” the data structure S_{w} built by P_{w}, obtaining the graph r⁻¹(S_{w}), which may be decoded by the decoder d. When P_{w} is run with arbitrary input k^{′}, the watermark is revealed when k′ is equal to the secret input key k:
d(X(P_{w},k))=d(r⁻¹(S_{w}))=w

In some applications it may be advantageous if the watermark is not revealed for some (or all) other possible inputs k′≠k:
d(X(P_{w},k))≠w

In some applications it may be advantageous for P_{w} to build the watermark w before any input is processed, in which case the secret input k is a null input sequence, Φ₀.

In some applications it may be advantageous if the watermark's presence or absence is signalled by a recognition function X′ with three arguments, such that

$${X}^{′} ( {P}_{w} , {k}^{′} , {w}^{′} ) = \{ \begin{matrix}true , & if d ( X ( Pw , {k}^{′} ) ) = {w}^{′} \\ false , & otherwise\end{matrix}$$

Another known arrangement is taught in a paper by Palsberg et al, “Experience with software watermarking”, in Proceedings 16^{th} Annual Computer Security Applications Conference (ACSAC'00), 2001, IEEE Computer Society, pp 308-316. This paper teaches an approach to tamperforoofing based on deriving opaque predicates (guards) from a watermark that takes the form of a PPCT.

Palsberg et al's approach is applied to constant Boolean values, which are introduced into the program along with conditional statements that are controlled by these newly introduced values. The resulting program is more difficult to understand, and is tamperproof in the following sense. A reverse engineer is likely to introduce errors into such a program if they modify the newly introduced conditional statements without a good understanding of whether or not the controlling constant will evaluate true or false.

Palsberg's method may be explained briefly as follows. The first step is to choose a graph w′ from the same set G as the watermark W. The second step is to modify the watermarked program in such a way that the modified program builds a data structure representing the graph w′ at the very beginning of its execution. The third step is to insert opaque predicates of the form (x==y) or (x !=y),where x and y are pointers into w′. Opaque predicates that evaluate to the constant value true are used to guard semantically-important regions of the watermarked code; and opaque predicates that evaluate to the constant value false are used to guard spurious code that, if executed, would damage the correctness of the watermarked code. An expert attacker who engages in extensive program analysis will eventually be able to distinguish w′ from w, and thus such an attacker may be able to remove w′ because w′ can defend w but w′ cannot be used to tamperproof itself. This places a defender employing Palsberg's method in a “chicken-and-egg” conundrum, whereby they would like to include a precursor data structure w″ that will defend w′; and a w′″ to defend w″; . . . ad nauseum.

### SUMMARY

Disclosed are arrangements which seek to address the above problems.

The gist of the invention is to replace a constant in said computer program with a function call, the function call having one or more arguments that point to a data structure built by said program. The replacement can involve referencing a data sub-structure defined by one or more of its arguments, and decoding the constant from the sub-structure.

Disclosed are methods, systems and computer program products embodying the invention.

### BRIEF DESCRIPTION OF THE DRAWINGS

Aspects of the prior art and one or more embodiments of the present invention will now be described with reference to the drawings and appendices, in which:

FIG. 1 shows a schematic block diagram of a known arrangement for watermarking software;

FIG. 2 is a schematic block diagram of tamperproofing watermarked software embodying the invention;

FIGS. 3 and 4 are dynamic graph structures;

FIGS. 5A-5D show dynamic graph structures and a depth first search operation;

FIG. 6 shows a dynamic graph structure derived from FIG. 5A; and

FIG. 7 is a schematic block diagram of a general purpose computer upon which arrangements described can be practiced.

### DETAILED DESCRIPTION INCLUDING BEST MODE

Introduction

Some portions of the description which follows are explicitly or implicitly presented in terms of algorithms and symbolic representations of operations on data within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that the above and similar terms are to be associated with the appropriate physical quantities and are merely convenient labels applied to these quantities. Unless specifically stated otherwise, and as apparent from the following, it will be appreciated that throughout the present specification, discussions utilizing terms such as “scanning”, “calculating”, “determining”, “replacing”, “generating” “initializing”, “outputting”, or the like, refer to the action and processes of a computer system, or similar electronic device, that manipulates and transforms data represented as physical (electronic) quantities within the registers and memories of the computer system into other data similarly represented as physical quantities within the computer system memories or registers or other such information storage, transmission or display devices.

PPCT trees

It is useful at this juncture to introduce characteristics of PPCT trees. A graph-theoretic tree is a planted plane cubic tree, referred to here as a PPCT tree, if it has the following properties:
1. The tree is embedded in the plane.
2. All vertices are either monovalent or trivalent.
3. A single vertex is distinguished as the root of the tree.
4. The root is monovalent.

Vertices and edges in PPCT trees correspond to node objects and pointer references respectively in the PPCT data structures. The data structures used are directional ones with either two or zero outgoing reference pointers for every node object with the exception of the root. The root has only one outgoing edge. Further, the order of the outgoing edges is important. The notation of left child and right child is used to distinguish the two children of any node.

Overview

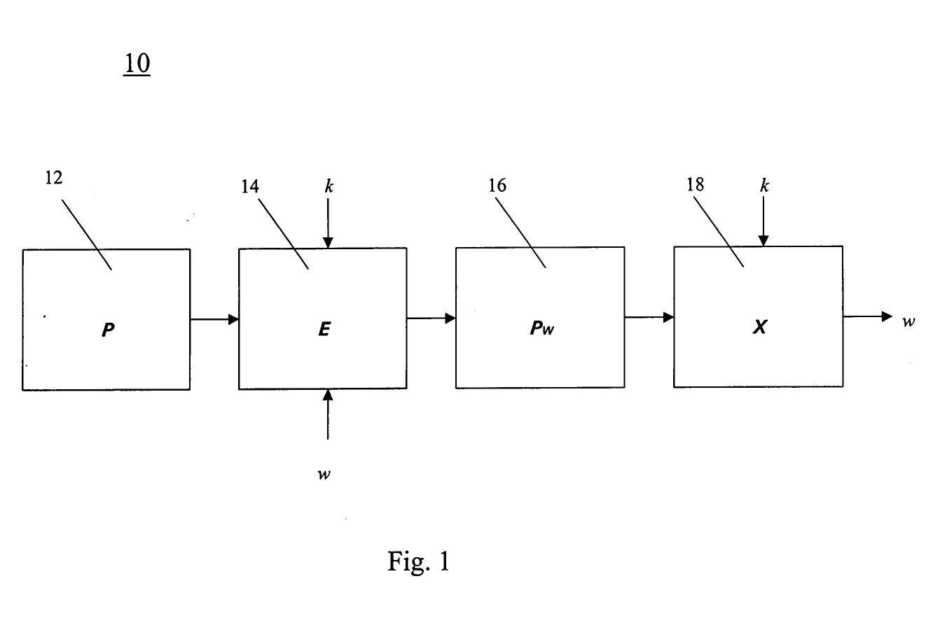

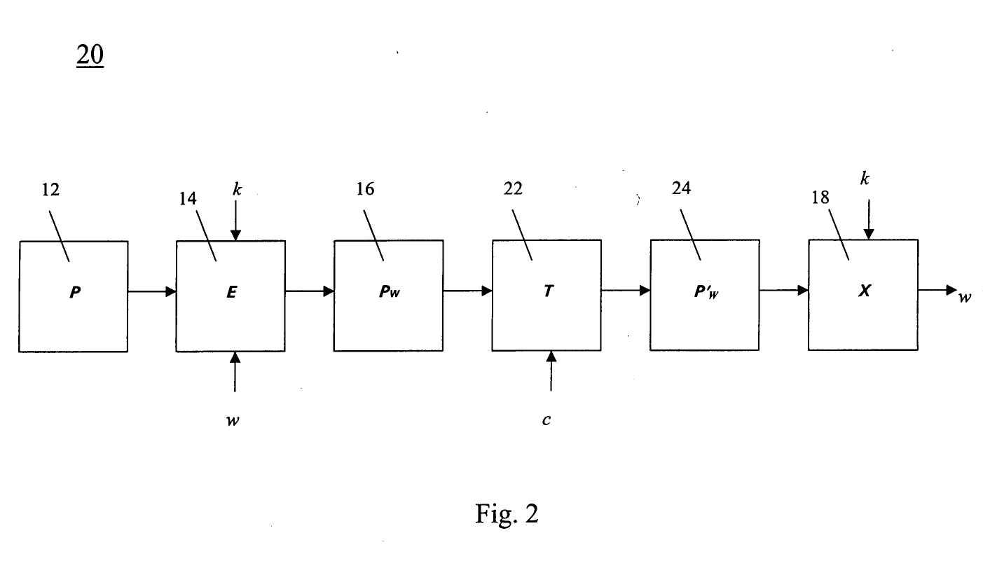

FIG. 2 shows a schematic block diagram embodying the tamperproofing of a watermarked program. It is to be taken that the watermarking is performed in accordance with the Collberg and Thomborson approach as discussed above, particularly with reference to FIG. 1. However, it is not necessary for the watermark to be embedded in the manner taught by Collberg and Thomborson, rather, it is enough that a program P_{w} has a watermark w that can be read by the program. An example of such is taught in U.S. Pat. No. 5,745,569 (Moskowitz et al), issued on 28 Apr., 1998. For example if the digitally-readable w is an integer watermark, then the program may interpret it as a graphical watermark e(w) for purposes of the tamperproofing described herein. As is well known to those skilled in the art of computer programming, any data value (such as a watermark) may be interpreted as an integer; and a “hash function” or other shortened version of this integer w may be used if w is of an inappropriately large size for the tamperproofing.

The additional modules in FIG. 2 are a tamperproofing module/process 22 that produce a modified watermarked program P′_{w}. The tamperproofing provides what is termed “constant encoding”, that replaces constants used in programs with a functionƒwhose value is dependent on the values of pointer variables in the dynamic data structure S_{w} that contains the watermark w.

In a generalised sense, the constant encoding method is implemented with an algorithm T:
T:P×Z→P
having the following properties:
1. The inputs to T are a watermarked program P_{w}εP and an integer CεZ, where P is the set of legal programs and Z is the set of constants that may appear in these programs.
2. The output of T is a modified program P′_{w} with the same watermarking behavior: for all inputs iεI:
   d(X(P′_{w},i))=d(X(P_{w},i))
3. The observable behavior of P′_{w} does not differ from P_{w} in any important manner, that is, T preserves the semantics of the program P_{w}.
4. The algorithm T may be executed repeatedly, until a desired amount of tamperproofing is achieved.
5. The algorithm T selects a statement p_{c} from P_{w}, where p_{c} is chosen randomly from the set of all statements in P_{w} which make use of the constant c.
6. The algorithm T constructs program P′_{w} which differs from P_{w} at the statement p_{c}, the constant-loading portion of which is replaced by a function call ƒ(a₁, a₂, . . . , aₙ).
7. The arguments a₁, a₂, . . . , aₙ and the function η( . . . ) are chosen appropriately by algorithm T, to ensure that the result value of the function call ƒ(a₁, a₂, . . . , aₙ) is invariant over all execution paths leading to this call. This guarantees the semantic equivalence of P′_{w} and P_{w}, as required by property (3) above.
8. One or more of the arguments a₁, a₂, . . . , aₙ should be pointers (references) into the data structure built by P′_{w}. These arguments may reference areas of the data structure in which the watermark is embedded. The desired property of the pointer arguments is to provide tamperproofing of the watermark, in the following sense: if the data structure is altered indiscriminately by an attacker, in an attempt to remove its watermark, then ƒ( ) may evaluate incorrectly and the program semantics may change.
9. One or more of the arguments a₁, a₂, . . . , aₙ may be integer constants.
10. Randomisation (or other means unpredictable to the potential attacker) should be used in the selection of ƒ( . . . ), and of the value of each its arguments a₁, a₂, . . . , aₙ. This random selection should be made over an extremely large range of possible variants that would evaluate to the same constant c; in mathematical terminology, the function ƒ should be a many-to-one function, where the domain of its arguments is greatly larger than the range of its results. The desired property of this randomised selection process is to prevent any reverse engineer from building a small but comprehensive catalog, or other compact description, of all ƒ(a₁, a₂, . . . , aₙ) that may appear in a tamperproofed program. If, on the contrary, the range of possibilities were small, then a reverse engineer could successfully analyse each possible ƒ(a₁, a₂, . . . , aₙ) to discover the constant value c it would compute in various program contexts. After organising the knowledge into a catalog or some other compact representation, the reverse engineer could then efficiently recognise all ƒ(a₁, a₂, . . . , aₙ) in the watermarked program, replacing each by the constant it computes. Thus, if it were feasible to construct a small catalog, the tamperproofing on the watermark could be removed, and therefore the watermark itself could be removed or modified without concern for program correctness.
11. The decoding function d used by the extractor function X 18 should be functionally present in the tamperproof watermarked program. The presence of this function will provide an additional form of tamperproofing against an attacker who falsely argues that the watermark data structure S_{w} should be decoded by some decoder d′ constructed by the attacker for the purposes of this false argument. Any attacker who constructs a false decoder d′ may argue that S_{w} should be decoded by this decoding function, thereby providing false evidence that the watermark integer is any desired value w′=d′(X(S_{w})).
12. The algorithm T may, in an initial step, modify the program P_{w} so that the modified program P′_{w} builds a modified data structure S′ with the desirable properties of stealth and invariance, described briefly below. The data types and operations used to create new regions of, or to modify existing regions of, the data structure S of the original program P_{w} should closely resemble the data types and operations used to create the watermarked data structure(s) in P_{w}. This stealthiness or close resemblance will make it difficult for an attacker to distinguish the modified regions from the watermarked regions. The desired invariance property of S′ is that algorithm T, in any of its (possibly repeated) applications, will have efficient means of discovering (or recalling, by table lookup or other means of memorisation) pointers or references into S′ that have desirable values as arguments of ƒ( . . . ), where these desirable values are invariant over all execution paths leading to function call ƒ( . . . ).
13. The function ƒ( . . . ) should have a desirable invariance property described briefly below. The desired invariance property of ƒ( . . . ) is that algorithm T, in any of its (possibly repeated) applications, will have efficient means of discovering (or recalling, by table lookup or other means of memorisation) pointers or references into S′ whose variation, over all execution paths leading to function call ƒ( . . . ), can not affect the value of ƒ( . . . ). For example a function ƒ( . . . ) would have the desirable invariance property if its value were unaffected by the structure of the right-child descendants (if any) of its first argument, where this first argument is a reference to a representation of node in a binary tree. This would be a desirable function for the tamperproofing of a region of data structure S′ representing a node of a watermark tree with a known (invariant) structure in its left-child.
14. The algorithm T could have the capacity to modify the program P_{w} so that the modified program P′_{w} has a program variable whose presence is necessary for correct operation, with the property that the current value of this variable is decoded by a function call ƒ( . . . ) of the form described above. Alternatively, a suitably skilled operator may insert a small number of such instances in which program variables depend on arguments of ƒ( . . . ). The desired property of this introduction of variable dependency is to prevent an attacker from mounting a possible “pattern-matching” attack on the tamperproof watermarked program. In this potential attack, an attacker may discover a pattern or other distinctive signature of all function calls ƒ( . . . ) inserted by the claimed tamperproofing invention. The attacker may then, over an extended period of time, observe the operation of the program using a debugger or other means, to discover the value returned by every such ƒ( . . . ). Once all such values have been discovered, the attacker may then be able to replace all ƒ( . . . ) by the appropriate constant value, and the attacker may subsequently modify the watermark without damage to program correctness. This attack will require considerable skill, diligence and resources on the part of the attacker. The necessary level of skill, diligence, and resources for a successful attack will be greatly increased for each introduced instance where a function call ƒ( . . . ) returns a non-constant value. Such instances may be conveniently introduced by methods known to those of ordinary skill in program obfuscation. For example a program loop may be unrolled once, allowing a variation in program coding such that even-numbered iterations of the loop require a “True” value of a newly-introduced Boolean variable for correctness, while odd-numbered iterations of the loop require a “False” value for correctness.
15. The algorithm T could have the capacity to modify the program P_{w} so that the modified program P′_{w} has function calls ƒ( . . . ) of the form described above in “dead code” that will never be executed. Alternatively, a suitably skilled operator may insert a small number of such instances where ƒ( . . . ) is called by dead code. Such dead calls of ƒ( . . . ) should be selected in a manner that closely resembles the selection of the constant-generating ƒ( . . . ) of this invention. The desired property of this dead-call insertion is to further dissuade attackers from pattern-matching attacks, of the form described above. Such attacks will be extremely costly in cases where the attackers are unable to distinguish dead code from live code, for example when dead code is introduced into a program by strong obfuscation techniques such as the “opaque predicates” taught in International Patent Application No. WO 99/01815, entitled Obfuscation Techniques for Enhancing Software Security (inventors: Collberg, C., Low, D. and Thomborson, C.).

### Example

Consider the following simple program.

Public class A{

int a;
public void print ( ) {

a = 2;
System.out.println (a) ;

}
public static void main (String[ ] args) {

new A ( ) .print ( ) ;

}

}

This program, which has no watermark, builds a single dynamic data structure to hold the value of its variable a, being the constant value “2”.

Consider now the following program that includes an embedded watermark. Newly introduced statements are shown in boldface.

Public class A{

int a;
DGW g; //dynamic graph watermark
public void print ( ) {

g = build_DGW_watermark( 7 ) ;
a = 2;
System.out.println (a) ;

}
public static void main (String[ ] args) {

new A ( ) .print ( ) ;

}

}

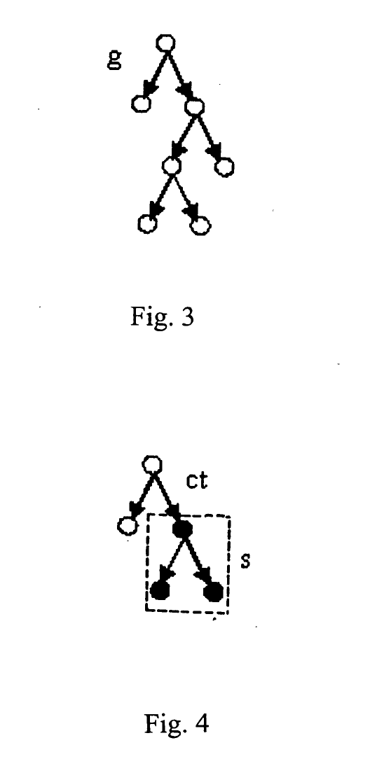

The watermark is embedded as a dynamic graph structure g encoding the watermark value 7, as shown in FIG. 3.

Consider now the following program embodying the invention.

Public class A{

| int a; | |
|---|---|
| DGW g; | //dynamic graph watermark |
| DGW ct; | //constant tree |
| DGW s; | //substructure of ct |

public void print ( ) {

ct = build_DGW_for_Constant ( ) ;
g = build_DGW_watermark( 7 ) ;
s = t(a₁, a₂, a₃); //finding structure s in ct
a = d(s); //retrieved value 2 from s
System.out.println (a) ;

}
public static void main (String[ ] args) {

new A ( ) .print ( ) ;

}

}

The program builds the same dynamic graph watermark g, shown in FIG. 3, and another stealthy graph structure ct of the same datatype as g. The structure ct has a substructure s of some desired invariant value, shown in FIG. 4. The key to the tamperproofing is (i) the selection of values for the arguments a₁, a₂, a₃, and (ii) the selection of functions t( . . . ) and d( . . . ). As noted in the description of the tamperproofing algorithm T above, the arguments and functions are selected randomly from an extremely wide range of choices that are guaranteed to maintain semantic equivalence. For example the argument a₁ could be a pointer to some part of graph ct. The argument a₂ could be a pointer to some other part of graph ct. The argument a₃ could be a pointer to some part of graph g. And the function t( . . . ) may be selected from a range of possible functions (described below) which, when given these arguments as parameters, share the required property that the result of this function evaluation is a substructure s that is decoded as the desired constant: d(s)=2.

In terms of the generalised expression given above, ƒ(a₁, a₂, . . . , aₙ) is equivalent to d(t(a₁, a₂, a₃) where d is the decoding function used to convert the watermark graph into a recognisable watermark integer. The graphs g and ct are subsets of the data structure S built by the watermarked program.

It is simplest to select the function t( . . . ) before selecting the values of its arguments.

Choice of Functions

Two basic classes of functions with the desired properties are identified. Those skilled in the art of functional programming will know that an unbounded number of functions, also bearing the desired properties, can be constructed from these base classes with the aid of elementary higher-order functions such as composition, mapping and filtering.

The exposition of these classes is based on some elementary functions, defined immediately below, on trees derived from data structures. The function t(a) is written to denote the (unique) tree rooted at some node a, where this tree is the set of all data structure nodes reachable from a with a depth-first search. The total ordering on the outgoing arcs from each node unambiguously defines the depth first search.

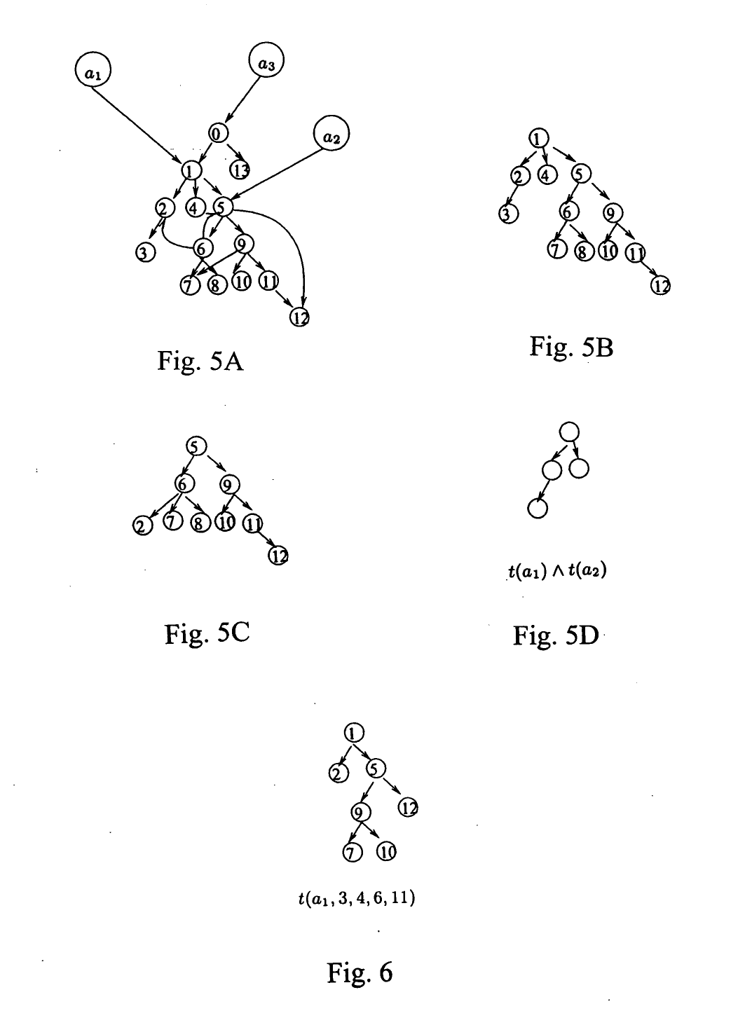

The intersection of two trees, t₁\hat{ }t₂, is defined in the natural way outlined below. If either tree is null then the intersection is null. If the root of t₁, has j children and the root of t₂ has k children, then the root of t₁\hat{ }t₂ has min(j, k) children. The structure of the subtrees rooted at each of these children is defined recursively. Thus, the leftmost child of the root of t₁∩t₂ has min(j′, k′) children if the leftmost child of the root of t₁ has j′ children and the leftmost child of the root of t₂ has k′ children. This idea is illustrated in FIGS. 5A-5D. FIG. 5A is a graph represented by a data structure with nodes labelled by a depth-first search beginning at the node (labelled 0) referenced by pointer a₃ . FIG. 5B is the tree t₁=t(a₁). FIG. 5C is the tree t₂=t(a₂). FIG. 5D is the tree representing the intersection of these two trees.

Masking Function

The simplest member of the first class of functions is a 2-argument masking function of the form tₘ(a,b) where a and b are pointers into the data structure S built by the watermarked program.

Define tₘ(a, b) as the intersection of t(a) and t(b):
tₘ(a,b)=t(a)\hat{ }t(b)

The function tₘ( . . . ) is called a “masking” function because the tree represented by its second argument is used to “mask” (or filter) the nodes in the tree represented by the first argument. The two argument tₘ(a, b) has the desired many-to-one property if its arguments are subtrees of a large tree: a tree of any desired shape (such as that shown in FIG. 5D) can be constructed in many ways, by intersecting various subtrees. For example, in FIGS. 5A-5D, t_{m l (a}₁, a₂)=tₘ(a₁, a₃).

Extension 1: The second argument of tₘ( . . . ) may be an integer encoding a binary tree as a totally balanced sequence. Several integers may be used for the same constant to ensure that the function is a many-to-one function.

Extension 2: The union of two trees may be defined analogously to the intersection operation on two trees, if min is replaced by max in the recursive definition for the intersection function given above. A masking function may therefore have any desired number of arguments:
tₘ(a₁, a₂ , . . . , aₙ)=F(a₁, a₂ , . . . aₙ)
where F is any desired tree-valued function obtained by union and intersection. For example, a three-argument masking function could be defined as:
tₘ(a,b,c)=(t(a)\hat{ }t(b)) [symbol] t(c)

Using the class of masking functions defined by these two extensions, those with ordinary skill in the art of graph algorithms will be able to devise a randomised algorithm for the selection (over an extremely wide range of possibilities) of a tree-valued function F and parameters a₁, a₂, . . . , aₙ such that d(F(a₁, a₂, . . . , aₙ)) for any desired constant c, where d is the decode function used by the watermark embedder 14.

An additional constraint may be placed on this randomised selection, by those skilled in the art of graph algorithms, so that a masking function will have the desired invariance property of always returning the desired value even if one or more of its arguments has some variation in its possible values. For example, the value of the simplest two-input masking function tₘ(a, b) is unaffected by any changes in the structure of the right-child descendants (if any) of its first argument, in contexts where its second argument is known to have no right-child descendants. This function would thus be one of many desirable choices, among the multitude of masking functions with the same functional invariance on their first argument, for the tamperproofing of a region of data structure S′ representing a node of a watermark tree with a known (invariant) structure in its left-child.

Boundary Function

The class of boundary functions t_{b}(r, a₁, a₂, . . . , aₙ) is similar to the class of masking functions, in that a boundary function also returns a tree defined by its arguments. Boundary functions differ from masking functions in way the tree is defined. Boundary functions have an argument r defining a sub-tree t(r) using a depth-first search, and the remaining arguments a₁, a₂, . . . ₄ an define “boundaries” that cut off portions of t(r) by the following algorithm.
1. Perform a depth first search from node r to discover the nodes of t(r), terminating the search whenever a node referenced directly by any of (a₁, a₂, . . . , aₙ) is encountered.
2. Return a tree t_{b}(r, a₁, a₂, . . . , aₙ) composed of all nodes encountered in the search, not including the terminating nodes. FIG. 6 shows an example, being the tree t_{b}(a₁,3,4,6,11).

Note that the list of boundaries (a₁, a₂, . . . , aₙ) may contain nodes that are not found in the search of t(r). Hence t_{b} has the desired many-to-one property. For example the tree in FIG. 6 can also be referenced as t_{b}(a₁,3,4,6,11,8). The desired invariance property is also present in t_{b}(r, a₁, a₂, . . . , aₙ) because one or more of the boundaries (a₁, a₂, . . . , aₙ) may be arbitrary references to watermarked portions of the data structure, in contexts where Algorithm T has determined that sub-tree t(r) is disjoint from the watermarked portions of the data structure.

Choice of Arguments for the Tamperproofing Function ƒ( )

Those of ordinary skill in the art of algorithmic design and analysis will be able to conduct experiments and to prove lemmas, of the sort described briefly below, to verify that each integer constant commonly occurring in a computer program may be decoded (by decoding function d of the codec employed by watermark embedder 14) from an extremely wide range of arguments to a wide variety of the tamperproofing functions described above. For example if we choose a random integer w to be a watermark, where w is uniformly distributed over the range [0,C₂₀₀-1]], then the PPCT representation t_{w}=e₁(w) of this watermark will have 201 leaves when it is encoded by the codec described in Algorithm 1 above. If two nodes a and b are chosen uniformly at random from among the nodes of this randomly chosen watermark tree t_{w}, then the integer decoded from the simplest 2-input masking function tₘ(a, b) will have a probability greater than 75% of being in the range [0,1]. This fact is easily verified by those of ordinary skill in combinatorial analysis, who will be able to calculate that there are (400)²=160,000 different ways of selecting two nodes a and b from a tree with 201 leaves, that there are more than 120,000 different ways to select two nodes a and b such that at least one of these two nodes is either a leaf or a node at distance one from a leaf, and that d₁(tₘ(a,b)) will be an integer in the range [0,1] whenever tₘ(a, b) is a tree with one or two leaves. Thus our simplest 2-input masking function strongly exhibits the desired “many-to-one” property. Furthermore, because a “0” is always decoded by d₁(tₘ(a,b)) if one of the two arguments is a leaf node, this function tₘ(a, b) has the desired invariance property. An attacker will have to engage in extensive program analysis to discover this invariance property. Without knowledge of this invariance property the attacker can not safely replace the function call tₘ(a, b) by a constant “0”, nor can they safely modify the watermark.

Constants larger than “0” or “1” may be decoded from trees as well, even though the many-to-one property of the simplest 2-input masking function does fall sharply with the size of the integer constant. With probability in excess of 90%, all integers in the range [0,63] can be decoded by at least one selection of arguments a and b for use in the function tₘ(a, b), where arguments a and b are taken from the nodes of a randomly-chosen 201-leaf watermark tree t_{w}. To decode large constants, with the desired many-to-one property, the more complex masking and boundary functions described in this patent may be employed by one of ordinary skill in the art in algorithmic design. Arbitrarily-large constants may also be decoded by the well-known technique of bit-string concatenation, for example a 2-bit constant may be constructed by concatenating two 1-bit constants that are decoded individually from trees referenced by simple masking or boundary functions.

Functions e(s) and d(t)

We use well-known techniques from combinatorial graph theory to design codecs that convert integers into trees and vice versa. Two implementations of these techniques will be described very briefly below. Both implementations use PPCT trees represented as PPCT data structures.

Algorithm 1

The codec (e₁, d₁) is based on ranking left-balanced trees higher than right-balanced trees.

The decoder d₁:Gₙ→N is defined recursively, for any fixed n>1, as follows:
d₁(g)=0, if |g|=1

$${d}_{1} ( g ) = {d}_{1} ( {g}_{L} ) {C}_{R} + d ( {g}_{R} ) + {\sum }_{i = 1}^{L - 1} {C}_{L - i} {C}_{R + i} , if \vert g \vert > 1$$

Here Gₙ is the set of all PPCTs with n leaves, g_{L} and g_{R} are the left and right sub-trees of the root of the tree g, and L=|g_{L}| and R=|g_{R}| are the number of leaves in each of these subtrees. Note that L+R=n, because tree g has n leaves. We write Cₙ for the n-th Catalan number:

$${C}_{n} = \frac{( \begin{matrix}2 n - 2 \\ n - 1\end{matrix} )}{n}$$

The recurrence relation appearing above is a corrected version of the one published by Palsberg et al., in “Experience with software watermarking,” Proceedings of the 16th Annual Computer Security Applications Conference, IEEE, pp. 308-316, 2000.

Anyone of ordinary skill in the art of combinatorial graph theory will be able to verify that, in the recurrence relation above, left-balanced trees (those with more leaves in the left sub-tree) decode to a greater value than the right-balanced trees with the same number (n) of leaves. The first term of the recurrence relation, d₁(g_{L})C_{R}, counts all the graphs g′ with the following properties: |g′_{L}|=g_{L}|, |g′_{R}|=|g_{R}, and d₁(g_{L})≧d₁(g′_{L}). The second term d₁(g_{R}) accounts for the graphs g′ with the same left-subtree as g but with different right sub-trees such that d₁(g_{R})≧d₁(g′_{R}). Finally the last term accounts for all the other graphs g′ with fewer leaves in its left sub-tree than that of g and more leaves in the right sub-tree. This understanding of the structure of d₁ allows one of ordinary skill in the art of combinatorial graph theory to construct an efficient implementation of the corresponding encoder function e₁, using techniques such as those described by D. L. Kreher and D. R. Stinson in Combinatorial Algorithms, CRC Press LLC, 1999.

Extension: In this extension the decoder function is defined over the expanded domain d′₁:{G₁, G₂ . . . , Gₙ}→N. This definition allows the PPCTs to have a variable number of leaves. No change is required to the defining recurrence relation above, for this relation has no dependence on n. This extension has the desirable “many-to-one property” for our tamperproofing, for it greatly increases the number of possible ways of decoding small integers, such as 0, that commonly occur as constants in computer programs.

Alporithm 2

An alternative method to encode PPCT graphs is based on encoding them as totally balanced binary sequences, and then enumerating these sequences using Catalan numbers. This algorithm uses only additions in all calculations, in marked contrast to the recurrence relation defining Algorithm 1 above, which requires one multiplication for each internal node in the tree (to form the product d₁(g₁)C_{R}) plus many additional multiplications to compute the summation in the third term for d₁(g). A suitable definition of totally balanced binary sequences, an implementation of this encoding algorithm, and an implementation of the corresponding decoding algorithm, may be found in D. L. Kreher and D. R. Stinson, Combinatorial Algorithms, CRC Press LLC, 1999.

Other suitable encoding and decoding algorithms, for the tamperproofing of watermarks in the form of PPCT trees and other data structures, may be implemented by those of ordinary skill in the design of combinatorial graph algorithms.

In some applications it may be advantageous to use several different codecs in a single tamperproof watermarked program.

Computer Platform

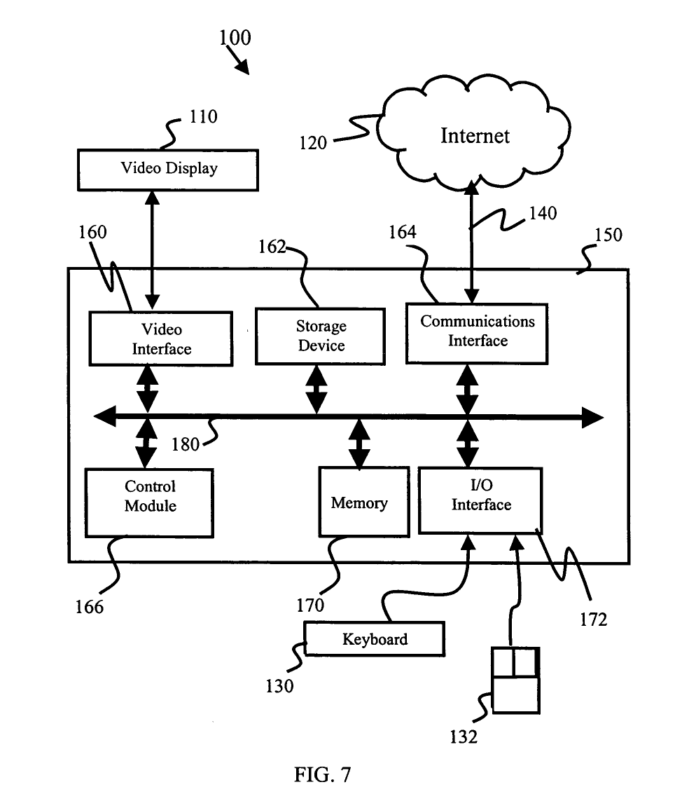

The method of FIG. 2 is preferably practiced using a general-purpose computer system 100, such as that shown in FIG. 7 wherein the processes of FIG. 2 may be implemented as software, such as an application program executing within the computer system 100. In particular, the steps of tamperproofing are effected by instructions in the software that are carried out by the computer. The instructions may be formed as one or more code modules, each for performing one or more particular tasks. It will be appreciated that a variety of programming languages and coding thereof may be used to implement the teachings of the disclosure contained herein. The software may also be divided into two separate parts, in which a first part performs the tamperproofing and a second part manages a user interface between the first part and the user.

The software may be stored in a computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The software is loaded into the computer from the computer readable medium, and then executed by the computer. A computer readable medium having such software or computer program recorded on it is a computer program product. The use of the computer program product in the computer preferably effects an advantageous apparatus for a secure computing platform which incorporates a watermark embedder and/or reader. The computer system 100 is formed by a computer module 101, input devices such as a keyboard 102 and mouse 103, output devices including a printer 115, a display device 114 and loudspeakers 117. A Modulator-Demodulator (Modem) transceiver device 116 is used by the computer module 101 for communicating to and from a communications network 120, for example connectable via a telephone line 121 or other functional medium. The modem 116 can be used to obtain access to the Internet, and other network systems, such as a Local Area Network (LAN) or a Wide Area Network (WAN), and may be incorporated into the computer module 101 in some implementations. The computer module 101 typically includes at least one processor unit 105, and a memory unit 106, for example formed from semiconductor random access memory (RAM) and read only memory (ROM). The module 101 also includes an number of input/output (I/O) interfaces including an audio-video interface 107 that couples to the video display 114 and loudspeakers 117, an I/O interface 113 for the keyboard 102 and mouse 103 and optionally a joystick (not illustrated), and an interface 108 for the modem 116 and printer 115. In some implementations, the modem 1116 may be incorporated within the computer module 101, for example within the interface 108. A storage device 109 is provided and typically includes a hard disk drive 110 and a floppy disk drive 111. A magnetic tape drive (not illustrated) may also be used. A CD-ROM drive 112 is typically provided as a non-volatile source of data. The components 105 to 113 of the computer module 101, typically communicate via an interconnected bus 104 and in a manner which results in a conventional mode of operation of the computer system 100 known to those in the relevant art. Examples of computers on which the described arrangements can be practised include IBM-PC's and compatibles, Sun Sparcstations or alike computer systems evolved therefrom.

Typically, the application program is resident on the hard disk drive 110 and read and controlled in its execution by the processor 105. Intermediate storage of the program and any data fetched from the network 120 may be accomplished using the semiconductor memory 106, possibly in concert with the hard disk drive 110. In some instances, the application program may be supplied to the user encoded on a CD-ROM or floppy disk and read via the corresponding drive 112 or 111, or alternatively may be read by the user from the network 120 via the modem device 116. Still further, the software can also be loaded into the computer system 100 from other computer readable media. The term “computer readable medium” as used herein refers to any storage or transmission medium that participates in providing instructions and/or data to the computer system 100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 101. Examples of transmission media include radio or infra-red transmission channels as well as a network connection to another computer or networked device, and the Internet or Intranets including e-mail transmissions and information recorded on Websites and the like.

The tamperproofing of watermarked programs may alternatively be implemented in dedicated hardware such as one or more integrated circuits performing the functions or sub functions of tamperproofing, evaluation of masking or boundary functions, decoding of constants from sub-trees or other graph-theoretic structures, and/or extraction of watermarks. Such dedicated hardware may include graphic processors, digital signal processors, or one or more microprocessors and associated memories.

Industrial Applicability

It is apparent from the above that the arrangements described are applicable to the computer and data processing industries.

The foregoing describes only some embodiments of the present invention, and modifications and/or changes can be made thereto without departing from the scope and spirit of the invention, the embodiments being illustrative and not restrictive.

1. A method of tamperproofing a computer program, comprising replacing a constant in said computer program with a function call, the function call having one or more arguments that point to a data structure built by said program.

2. The method of claim 1, wherein said step of replacing includes a first step of referencing a data sub-structure defined by one or more of its arguments, and a second step of decoding said constant from said sub-structure.

3. The method of claim 2, wherein said data sub-structure arises by the computation of one or more intersections or unions of other data sub-structures also defined by said arguments.

4. The method of claim 2, wherein said data sub-structure arises by the delimitation of another data sub-structure defined by said arguments, where the boundary of said delimitation is also defined by said arguments.

5. The method of claim 2, wherein said computer program further includes code defining a watermark data structure.

6. The method of claim 5, wherein said computer program further includes code that will build a stealthy data structure that resembles said watermark data structure, and at least one of said arguments points to said stealthy data structure.

7. The method of claim 6, wherein at least one of said arguments points to said watermark data structure.

8. The method of claim 1, wherein at least one other function call similar to said function call is used to decode values of variables.

9. The method of claim 1, wherein at least one other function call similar to said function call is introduced into dead code.

10. A method of tamperproof watermarking a computer program, comprising:
(a) inserting watermark code into said computer program that builds a watermark graph structure; and
(b) replacing a constant in said computer program with a function call, the function call having arguments, one or more said arguments pointing to a sub-structure built by the function executed by said function call, and one or more said arguments pointing to said watermark structure.

11. A method of tamperproofing a watermarked computer program, comprising:
analysing a computer program to find a point at which it references a constant value;
analysing said computer program to find all execution paths leading up to said point;
analysing said execution paths to discover program variables whose values at said point are invariant over all said paths;
selecting a function for insertion in said program, from a collection of functions with a many-to-one property;
selecting at least one pointer argument for said function, from program variables which may reference the watermark, or from program variables with known invariance properties;
inserting said function call and its list of arguments at the point of reference to said constant value; and
removing said constant value from the program.

12. A system for verifying ownership of a computer program, comprising:
(a) an embedder module receiving a computer program, an input key, and a desired watermark number, said embedder module producing as output a tamperproof watermarked computer program incorporating a decoding function;
(b) a general-purpose computer executing said tamperproof watermarked computer program and said incorporated decoding function; and
(c) an extractor module that executes on a general-purpose computer, by examining the data structures of said tamperproof watermarked computer program when this program is presented said input key, testing for the presence of the watermark in said data structures by using either said incorporated decoding function or some other implementation of said incorporated decoding function.

13. A computer program product comprising a computer program and code means for replacing a constant in said computer program with a function call, the function call having one or more arguments that point to a data structure built by said program.
